(19) United States
(12) Patent Application Publication
(10) Pub. No.: US 2012/0231325 A1
(43) Pub. Date: Sep. 13, 2012

(54) ELECTROLYTE FOR A LITHIUM RECHARGEABLE BATTERY, LITHIUM RECHARGEABLE BATTERY INCLUDING THE SAME, AND METHOD OF MANUFACTURING A LITHIUM RECHARGEABLE BATTERY

(76) Inventors: Su-Jin YOON, Yongin-si (KR); Kwang-Soo Kim, Yongin-si (KR)

(21) Appl. No.: 13/301,177

(22) Filed: Nov. 21, 2011

Related U.S. Application Data
(60) Provisional application No. 61/451,450, filed on Mar. 10, 2011.

(51) Int. Cl. H01M 10/056; H01M 10/04; H01M 2/02

(52) U.S. Cl. 429/163; 429/326; 29/623.2

(57) ABSTRACT

A lithium rechargeable battery, an electrolyte for a lithium rechargeable battery, and a method of manufacturing a lithium rechargeable battery, the battery including an electrode assembly; a case accommodating the electrode assembly; and an electrolyte in the case, wherein the electrolyte includes a lithium salt; a non-aqueous organic solvent, the non-aqueous organic solvent including about 50 wt % or more of an ester-based solvent; lithium difluoro(oxalato)borate; and a first additive, the first additive including at least one selected from tris(trialkylsilyl)phosphate, tris(trialkylsilyl)phosphite, and tris(trialkylsilyl)borate.

### CROSS-REFERENCE TO RELATED APPLICATION

The present application claims priority under 35 U.S.C. §119(e) to U.S. Provisional Application No. 61/451,450, filed on Mar. 10, 2011, and entitled: “Non-Aqueous Electrolyte for Rechargeable Lithium Battery and Rechargeable Lithium Battery Including Same,” which is incorporated herein by reference in its entirety.

### BACKGROUND

1. Field

Embodiments relate to an electrolyte for a lithium rechargeable battery, a lithium rechargeable battery including the same, and a method of manufacturing a lithium rechargeable battery.

2. Description of the Related Art

Recently, energy-storing technology has drawn increasing attention. As a battery may be used for an electric car as well as a mobile phone, a camcorder, and/or a laptop PC, a higher energy density of the battery is desired. High energy density may be satisfied by a lithium rechargeable battery.

A lithium rechargeable battery may include a negative electrode (made of a carbon material or the like, which may intercalate and deintercalate lithium ions), a positive electrode (made of a lithium-containing oxide or the like), and a non-aqueous electrolyte (prepared by appropriately dissolving a lithium salt in an organic solvent).

### SUMMARY

Embodiments are directed to an electrolyte for a lithium rechargeable battery, a lithium rechargeable battery including the same, and a method of manufacturing a lithium rechargeable battery.

The embodiments may be realized by providing a lithium rechargeable battery including an electrode assembly; a case accommodating the electrode assembly; and an electrolyte in the case, wherein the electrolyte includes a lithium salt; a non-aqueous organic solvent, the non-aqueous organic solvent including about 50 wt % or more of an ester-based solvent; lithium difluoro(oxalato)borate; and a first additive, the first additive including at least one selected from tris(trialkylsilyl)phosphate, tris(trialkylsilyl)phosphite, and tris(trialkylsilyl)borate.

The non-aqueous organic solvent may include about 50 wt % to about 90 wt % of the ester-based solvent.

The ester-based solvent may include at least one selected from an alkyl acetate, an alkyl propionate, and a cyclic ester.

The ester-based solvent may include the alkyl acetate, the alkyl acetate including at least one selected from methyl acetate, ethyl acetate, n-propyl acetate, and isopropyl acetate.

The ester-based solvent may include the alkyl propionate, the alkyl propionate including at least one selected from methyl propionate, ethyl propionate, n-propyl propionate, and isopropyl propionate.

The ester-based solvent may include the cyclic ester, the cyclic ester including at least one selected from γ-butyrolactone, decanolide, valerolactone, mevalonolactone, and caprolactone.

The non-aqueous organic solvent may further include at least one selected from a carbonate-based solvent, an ether-based solvent, a ketone-based solvent, an alcohol-based solvent, and an aprotic solvent.

The non-aqueous organic solvent may include the carbonate-based solvent, the carbonate-based solvent being a cyclic carbonate, and the ester-based solvent and the cyclic carbonate may be included in a weight ratio of about 4:1 to about 1:1.

The lithium difluoro(oxalato)borate may be included in the electrolyte in an amount of about 0.1 wt % to about 5 wt %, based on a total weight of the electrolyte.

The lithium difluoro(oxalato)borate may be included in the electrolyte in an amount of about 0.5 wt % to about 5 wt %, based on a total weight of the electrolyte.

The first additive may include the tris(trialkylsilyl)phosphate, the tris(trialkylsilyl)phosphate including at least one selected from tris(trimethylsilyl)phosphate, tris(triethylsilyl)phosphate, and tris(tripropylsilyl)phosphate.

The first additive may include the tris(trialkylsilyl)phosphite, the tris(trialkylsilyl)phosphite including at least one selected from tris(trimethylsilyl)phosphite, tris(triethylsilyl)phosphite, and tris(tripropylsilyl)phosphite.

The first additive may include the tris(trialkylsilyl)borate, the tris(trialkylsilyl)borate including at least one selected from tris(trimethylsilyl)borate, tris(triethylsilyl)borate, and tris(tripropylsilyl)borate.

The first additive may be included in the electrolyte in an amount of about 0.1 wt % to about 5 wt %, based on a total weight of the electrolyte.

The electrolyte may include the lithium difluoro(oxalato)borate and the first additive in a weight ratio of about 1:0.5 to about 1:4.

The electrolyte may further include a second additive, the second additive including at least one selected from 1,3-propene sultone and vinylethylene carbonate.

The second additive may be included in the electrolyte in an amount of about 0.1 wt % to about 5 wt %, based on a total weight of the electrolyte.

The electrode assembly may include a positive electrode plate and a negative electrode plate, the positive electrode plate including a positive active material and the negative electrode plate including a negative active material, the positive active material may include a compound that reversibly intercalates and deintercalates lithium, and the negative active material may include a material that reversibly intercalates/deintercalates lithium ions, lithium metal, an alloy of lithium metal, a material that dopes and dedopes lithium, or a transition metal oxide.

The embodiments may also be realized by providing an electrolyte for a lithium rechargeable battery, the electrolyte including a lithium salt; a non-aqueous organic solvent, the non-aqueous organic solvent including about 50 wt % or more of an ester-based solvent; lithium difluoro(oxalato)borate; and a first additive, the first additive including at least one selected from tris(trialkylsilyl)phosphate, tris(trialkylsilyl)phosphite, and tris(trialkylsilyl)borate.

The embodiments may also be realized by providing a method of manufacturing a lithium rechargeable battery, the method including preparing an electrode assembly; accommodating the electrode assembly in a case; adding an electrolyte to the case; and sealing the case, wherein the electrolyte includes a lithium salt; a non-aqueous organic solvent, the non-aqueous organic solvent including about 50 wt % or more of an ester-based solvent; lithium difluoro(oxalato)borate; and a first additive, the first additive including at least one selected from tris(trialkylsilyl)phosphate, tris(trialkylsilyl)phosphite, and tris(trialkylsilyl)borate.

### BRIEF DESCRIPTION OF THE DRAWING

The embodiments will become apparent to those of ordinary skill in the art by describing in detail exemplary embodiments with reference to the attached drawing, in which:

FIG. 1 illustrates a schematic view of a rechargeable lithium battery according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing FIGURE, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

As used herein, when specific definition is not otherwise provided, the term “alkyl” may refer to a C1 to C7 or a C1 to C3 lower alkyl, e.g., methyl, ethyl, propyl, or isopropyl.

According to an embodiment, when an ester-based solvent is used in an amount of about 50 wt % or more (based on a total amount of a non-aqueous organic solvent), the non-aqueous organic solvent may help improve battery performance at a low temperature. In addition, when the non-aqueous organic solvent includes lithium difluoro(oxalato)borate, battery capacity, cycle-life, and performance may be improved. When a phosphate salt, a phosphite salt, and/or a boron acid salt as well as the lithium difluoro(oxalato)borate are used, the non-aqueous organic solvent may help improve battery characteristics at a low temperature and reduce or prevent battery deterioration and output deterioration when a battery is allowed to stand at a high temperature or a room temperature for a long time.

For example, a non-aqueous electrolyte for a rechargeable lithium battery may include a lithium salt; a non-aqueous organic solvent (including an ester-based solvent in an amount of about 50 wt % or more); lithium difluoro(oxalato)borate; and a first additive selected from the group of tris(trialkylsilyl)phosphate, tris(trialkylsilyl)phosphite, (trialkylsilyl)borate, and a mixture thereof.

Hereinafter, each component is described in detail.

Lithium Salt

The lithium salt may be dissolved in a non-aqueous organic solvent. The lithium salt may serve as a lithium ion source in a battery to facilitate basic function of a lithium rechargeable battery. The lithium salt may also promote lithium ion transfer between positive and negative electrodes. Examples of the lithium salt may include LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (herein, x and y are a natural number), LiCl, LiI, LiB(C₂O₄)₂ (lithium bis(oxalato)borate; LiBOB), or a mixture thereof, as a supporting electrolytic salt.

The lithium salt may be included in a concentration of about 0.1 to about 2.0M. Maintaining the concentration of the lithium salt at about 0.1 to about 2.0M may help ensure that the electrolyte has a suitable conductivity and viscosity. Thus, excellent electrolyte performance and effective transfer of lithium ions may be achieved.

Non-Aqueous Organic Solvent

The non-aqueous organic solvent may serve as a medium for transmitting ions taking part in electrochemical reaction of the battery.

The non-aqueous organic solvent may include an ester-based solvent in an amount of about 50 wt % or more, based on a total weight of the organic solvent. in an implementation, the ester-based solvent may be included in an amount of about 50 wt % to about 90 wt %.

Examples of the ester-based solvent may include an alkyl acetate (such as methyl acetate, ethyl acetate, n-propyl acetate, and the like); an alkyl propionate (such as methyl propionate, ethyl propionate, and the like); and/or a cyclic ester (such as γ-butyrolactone, decanolide, valerolactone, mevalonolactone, caprolactone, and the like). In an implementation, the ester-based solvent may include an alkyl propionate that helps improve battery performance at low temperature and helps prevent battery capacity deterioration when a battery is allowed to stand. For example, the alkyl propionate may include methylpropionate, ethylpropionate, or a mixture thereof. In another implementation, the alkyl may be a C1 to C10 alkyl.

The non-aqueous organic solvent of an embodiment may include a carbonate-based, an ether-based, a ketone-based, an alcohol-based, or an aprotic solvent along with the ester-based solvent.

The carbonate-based solvent may include a cyclic carbonate (such as dimethyl carbonate (DMC), diethyl carbonate (DEC), dipropyl carbonate (DPC), methylpropyl carbonate (MPC), ethylpropyl carbonate (EPC), methylethyl carbonate (MEC), ethylmethyl carbonate, or the like) and/or a linear carbonate (such as ethylene carbonate (EC), propylene carbonate (PC), butylene carbonate (BC), vinylene carbonate, or the like). Examples of the ether-based solvent may include dibutyl ether, tetraglyme, diglyme, dimethoxyethane, 2-methyltetrahydrofuran, tetrahydrofuran, and the like. Examples of the ketone-based solvent may include cyclohexanone and the like. Examples of the alcohol-based solvent may include ethyl alcohol, isopropyl alcohol, and the like. Examples of the aprotic solvent may include nitriles (such as R—CN (wherein R is a C2 to C20 linear, branched, or cyclic hydrocarbon group that optionally include a double bond, an aromatic ring, or an ether bond), acetonitrile, and the like), amides (such as dimethyl formamide), dioxolanes (such as 1,3-dioxolane), sulfolanes, sulfites (such as ethylene sulfite, propylene sulfite, and the like), alkoxyethanes (such as methoxyethane, diethoxyethane, and the like), sulfoxides (such as dimethylsulfoxide), and the like.

The non-aqueous organic solvent may be used singularly or in a mixture of two or more thereof. When the organic solvent is used in a mixture, a mixture ratio may be controlled in accordance with a desired battery performance.

The carbonate-based solvent may include a mixture of a cyclic carbonate and a linear carbonate. When the cyclic carbonate and the linear carbonate are mixed together in a volume ratio of about 1:1 to about 1:9 to prepare the electrolyte, performance of the electrolyte may be enhanced.

In an implementation, the electrolyte may further include mixtures of carbonate-based solvents and aromatic hydrocarbon-based solvents. The carbonate-based solvents and the aromatic hydrocarbon-based solvents may be mixed together in a volume ratio of about 1:1 to about 30:1.

The aromatic hydrocarbon-based organic solvent may be represented by the following Chemical Formula 1:

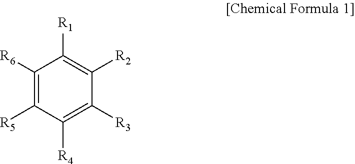

In Chemical Formula 1, R₁ to R₆ may each independently be hydrogen, a halogen, a C1 to C10 alkyl group, a C1 to C10 haloalkyl group, or combinations thereof.

For example, the aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or combinations thereof.

In an implementation, the non-aqueous organic solvent may include a mixture of the ester-based solvent and the cyclic carbonate. When the ester-based solvent and the cyclic carbonate are mixed together in a weight ratio of about 4:1 to about 1:1 to prepare the electrolyte, performance of the electrolyte may be enhanced.

In an implementation, the non-aqueous organic solvent may further include a mixture of an ethylene carbonate and methyl propionate or ethyl propionate.

Lithium Difluoro(oxalato)borate

The lithium difluoro(oxalato)borate may form a porous thin inorganic SEI layer and thus, cycle-life of a rechargeable lithium battery (when a battery is allowed to stand at a high temperature), low temperature characteristics, and output characteristics may be improved.

The lithium difluoro(oxalato)borate may be included in an amount of about 0.5 wt % to about 5 wt %, based on the total weight of the non-aqueous electrolyte. When the lithium difluoro(oxalato)borate is included within the range, excellent ion conductivity may be achieved.

First Additive

The non-aqueous electrolyte may include a first additive. The first additive may include, e.g., tris(trialkylsilyl)phosphate, tris(trialkylsilyl)phosphite, (trialkylsilyl)borate, and/or a mixture thereof. The first additive may help reduce or prevent battery capacity deterioration and improve output characteristics when a battery is allowed to stand at a high temperature or a temperature higher than a room temperature for a long time.

The first additive may work as a HF scavenger and may suppress LiF production on a surface of a negative electrode SEI layer during initial charging. Thus, output characteristics of a lithium rechargeable battery may be improved.

In an implementation, the first additive may include, e.g., a tris(trialkylsilyl)phosphate (such as tris(trimethylsilyl)phosphate, tris(triethylsilyl)phosphate, tris(tripropylsilyl)phosphate, and the like); a tris(trialkylsilyl)phosphite (such as tris(trimethylsilyl)phosphite, tris(triethylsilyl)phosphate, tris(tripropylsilyl)phosphate, and the like); and/or a tris(trialkylsilyl)borate (such as tris(trimethylsilyl)borate, tris(triethylsilyl)borate, tris(tripropylsilyl)borate, and the like) alone or as a mixture of two or more thereof. For example, the alkyl may include C1 to C3 alkyls.

The first additive may be included in an amount of about 0.1 wt % to about 5 wt %, based on the total weight of the non-aqueous electrolyte. When the first additive is included within the range, excellent ion conductivity may be achieved.

If an excessive amount of lithium difluoro(oxalato)borate is included (relative to the first additive) in the non-aqueous electrolyte, a dense SEI layer may be formed and power output may be deteriorated. In addition, non-reacting portions of the first additive may generate gas when the battery is allowed to stand at a high temperature. On the other hand, when an excessive amount of the first additive is included (relative to the lithium difluoro(oxalato)borate, battery characteristics (when the battery is allowed to stand) may be deteriorated. Thus, according to an embodiment, the non-aqueous electrolyte may include lithium difluoro(oxalato)borate and the first additive in a weight ratio of about 1:0.5 to about 1:4, e.g., from about 1:0.5 to about 1:2. Thus, output and characteristics when a battery is allowed to stand at a high temperature may be improved.

The non-aqueous electrolyte according to an embodiment may include a second additive. The second additive may be selected from the group of 1,3-propene sultone, vinylethylene carbonate, and a mixture thereof, to help reduce or prevent battery capacity and output deteriorations.

The second additive may be included in an amount of about 0.1 wt % to about 10 wt %, based on the total weight of the non-aqueous electrolyte. For example, 1,3-propene sultone may be included in an amount of about 0.1 wt % to about 5 wt %, and vinylethylene carbonate may be included in an amount of about 0.1 wt % to about 5 wt %, based on the total weight of the non-aqueous electrolyte.

The non-aqueous electrolyte may further include a third additive. The third additive may include a vinylene carbonate or an ethylene carbonate-based compound of the following Chemical Formula 2:

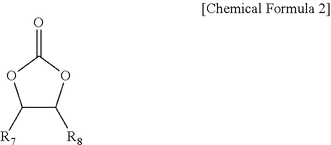

In Chemical Formula 2, R₇ and R₈ may each independently be hydrogen, a halogen, a cyano (CN), a nitro (NO₂), and/or a C1 to C5 fluoroalkyl, provided that at least one selected from R₇ and R₈ is a halogen, a nitro (NO₂), or a C1 to C5 fluoroalkyl, and R₇ and R₈ are not simultaneously hydrogen.

The ethylene carbonate-based compound may include fluoroethylene carbonate, difluoro ethylene carbonate, chloroethylene carbonate, dichloroethylene carbonate, bromoethylene carbonate, dibromoethylene carbonate, nitroethylene carbonate, cyanoethylene carbonate, or the like.

The use amount of the third additive for improving cycle life may be adjusted within an appropriate range.

Accordingly, the non-aqueous electrolyte according to an embodiment may help improve battery capacity, cycle-life, and performance deterioration while simultaneously helping reduce or prevent battery capacity and output deteriorations when the battery is allowed to stand at a high temperature or a room temperature.

According to another embodiment, a lithium rechargeable battery including the non-aqueous electrolyte is provided.

Lithium rechargeable batteries may include, e.g., lithium ion batteries, lithium ion polymer batteries, and/or lithium polymer batteries (according to the presence of a separator and a kind of electrolyte used therein). The lithium rechargeable batteries may have a variety of shapes and sizes, and may include cylindrical, prismatic, coin, or pouch-type batteries, and may be thin film batteries or may be rather bulky in size.

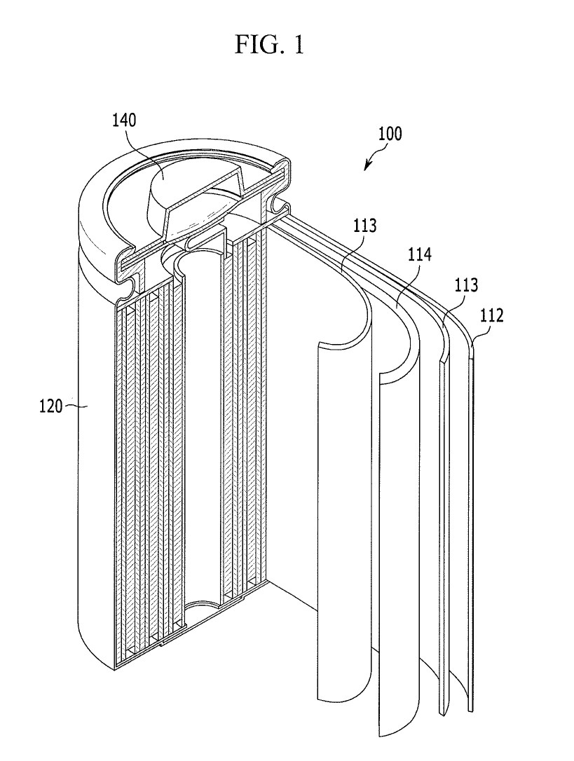

FIG. 1 illustrates an exploded perspective view showing a lithium rechargeable battery according to an embodiment. Referring to FIG. 1, the lithium rechargeable battery 100 may have a cylindrical shape and may include a negative electrode 112, a positive electrode 114, a separator 113 (interposed between the negative electrode 112 and the positive electrode 114), an electrolyte (not shown, impregnating or surrounding the separator 113), a battery case 120, and a sealing member 140 (coupled with the battery case 120). The lithium rechargeable battery 100 may be fabricated by sequentially stacking the negative electrode 112, the positive electrode 114, and the separator 113, spiral-winding them, and then housing the wound product in a container, e.g., the battery case 120.

The negative electrode 112 may include a current collector and a negative active material layer disposed thereon. The negative active material layer may include a negative active material.

Examples of the negative active material may include a material that reversibly intercalates/deintercalates lithium, a lithium metal, a lithium metal alloy, a material being capable of doping lithium, or a transition metal oxide.

The material that can reversibly intercalate/deintercalate lithium ions may include a carbon material. The carbon material may be any suitable carbon-based negative active material used in a lithium ion rechargeable battery. Examples of the carbon material may include crystalline carbon, amorphous carbon, or a mixture thereof. The crystalline carbon may be non-shaped, or sheet, flake, spherical, or fiber shaped natural graphite or artificial graphite. The amorphous carbon may be a soft carbon (carbon obtained through sintering at a low temperature), a hard carbon (carbon obtained through sintering at a high temperature), mesophase pitch carbonized product, fired coke, or the like.

Examples of the lithium metal alloy may include lithium and a metal selected from the group of Na, K, Rb, Cs, Fr, Be, Mg, Ca, Sr, Si, Sb, Pb, In, Zn, Ba, Ra, Ge, Al, and Sn.

Examples of the material capable of doping lithium may include Si, SiO, (0≦x≦2), a Si—X₁ alloy (where X₁ is an element selected from the group of an alkali metal, an alkaline-earth metal, a group 13 element, a group 14 element, a group 15 element, a group 16 element, a transition element, a rare earth element, and combinations thereof and not Si), Sn, SnO₂, a Sn—X₂ alloy (where X₂ is an element selected from the group of an alkali metal, an alkaline-earth metal, a group 13 element, a group 14 element, a group 15 element, a group 16 element, a transition element, a rare earth element, and combinations thereof, and is not Sn), or mixtures thereof. At least one selected from these materials may be mixed with SiO₂. Examples of the elements X₁ and X₂ may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and combinations thereof.

Examples of the transition metal oxide may include vanadium oxide, lithium vanadium oxide, and the like.

The negative active material layer may include a binder and optionally a conductive material.

The binder may improve binding properties of negative active material particles with one another and with the current collector. Examples of the binder may include polyvinyl alcohol, carboxylmethyl cellulose, hydroxypropyl cellulose, polyvinyl chloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may help improve electrode conductivity. Any suitable electrically conductive material that does not cause a chemical change may be used as the conductive material. Examples of the conductive material may include a carbon-based material (such as natural graphite, artificial graphite, carbon black, acetylene black, ketjen black, and/or a carbon fiber); a metal-based material (such as a metal powder or a metal fiber including copper, nickel, aluminum, silver, or the like); a conductive polymer (such as a polyphenylene derivative), or mixtures thereof.

The current collector may be selected from a copper foil, a nickel foil, a stainless steel foil, a titanium foil, a nickel foam, a copper foam, a polymer substrate coated with a conductive metal, or combinations thereof.

The positive electrode 114 may include a current collector and a positive active material layer disposed on the current collector.

The positive active material may include lithiated intercalation compounds that reversibly intercalate and deintercalate lithium ions. The positive active material may include a composite oxide including at least one selected from the group of cobalt, manganese, and nickel, as well as lithium. For ecample, the following lithium-containing compounds may be used: LiₐA_{1-b}R_{b}D₂ (wherein, in the above formula, 0.90≦a≦1.8 and 0≦b≦0.5); LiₐE_{1-b}R_{b}O_{2-c}D_{c} (wherein, in the above formula, 0.90≦a≦1.8, 0≦b≦0.5 and 0≦c≦0.05); LiE_{2-b}R_{b}O_{4-c}D_{c} (wherein, in the above formula, 0≦b≦0.5, and 0≦c≦0.05); LiₐNi_{1-b-c}Co_{b}RₑD_{c}, (wherein, in the above formula, 0.90≦a≦1.8, 0≦b≦0.5, 0≦c≦0.05 and 0≦α≦2); LiₐNi_{1-b-c}Co_{b}R_{c}O_{2-α}Z_{α} (wherein, in the above formula, 0.90≦a≦1.8, 0≦b≦0.5, 0≦c≦0.05 and 0≦α≦2); LiₐNi_{1-b-c}Co_{b}R_{c}O_{2-α}Z₂ (wherein, in the above formula, 0.90≦a≦1.8, 0≦b≦0.5, 0≦c≦0.05 and 0≦α≦2); LiₐNi_{1-b-c}Mn_{b}R_{c}D_{α} (wherein, in the above formula, 0.90≦a≦1.8, 0≦b≦0.5, 0≦c≦0.05 and 0≦α≦2); LiₐNi_{1-b-c}Mn_{b}R_{c}O_{2-α}Z_{α} (wherein, in the above formula, 0.90≦a≦1.8, 0≦b≦0.5, 0≦c≦0.05 and 0≦α≦2); LiₐNi_{1-b-e}Mn_{b}R_{c}O_{2-αZ}₂ (wherein, in the above formula, 0.90≦a≦1.8, 0≦b≦0.5, 0≦c≦0.05 and 0≦α≦2); LiₐNi_{b}E_{c}G_{d}O₂ (wherein, in the above formula, 0.90≦a≦1.8, 0≦b≦0.9, 0≦c≦0.5 and 0.001≦d≦0.1); LiₐNi_{b}Co_{c}Mn_{d}GeO₂ (wherein, in the above formula, 0.90≦a≦1.8, 0≦b≦0.9, 0≦c≦0.5, 0≦d≦0.5 and 0.001≦e≦0.1); LiₐNiG_{b}O₂ (wherein, in the above formula, 0.90≦a≦1.8 and 0.001≦b≦0.1); LiₐCoG_{b}O₂ (wherein, in the above formula, 0.90≦a≦1.8 and 0.001≦b≦0.1); LiₐMnG_{b}O₂ (wherein, in the above formula, 0.90≦a≦1.8 and 0.001≦b≦0.1); LiₐMn₂G_{b}O₄ (wherein, in the above formula, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂ (PO₄)₃ (0≦f≦2); and LiFePO₄.

In the above formulae, A may be selected from Ni, Co, Mn, and combinations thereof; R may be selected from Al, Ni, Co, Mn, Cr, Fe, Mg, Sr, V, a rare earth element, and combinations thereof; D may be selected from O, F, S, P, and combinations thereof; E may be selected from Co, Mn, and combinations thereof; Z may be selected from the group of F, S, P, and combinations thereof; G may be selected from Al, Cr, Mn, Fe, Mg, La, Ce, Sr, V, and combinations thereof; Q may be selected from Ti, Mo, Mn, and combinations thereof; T may be selected from Cr, V, Fe, Sc, Y, and combinations thereof; and J may be selected from V, Cr, Mn, Co, Ni, Cu, and combinations thereof.

The compound may have a coating layer on the surface, or may be mixed with another compound having a coating layer. The coating layer may include a coating element compound, e.g., an oxide of a coating element, a hydroxide, an oxyhydroxide of a coating element, an oxycarbonate of a coating element, or a hydroxylcarbonate of a coating element. The compound for a coating layer may be amorphous or crystalline. The coating element for a coating layer may include, e.g., Mg, Al, Co, K, Na, Ca, Si, Ti, V, Sn, Ge, Ga, B, As, Zr, or mixtures thereof. The coating layer may be formed in a method having no adverse influence on properties of a positive active material by including these elements in the compound. For example, the method may include any suitable coating method such as spray coating, dipping, and the like.

The positive active material layer may also include a binder and a conductive material.

The binder may help improve binding properties of the positive active material particles to one another and also with the current collector. Examples of the binder may include polyvinyl alcohol, carboxylmethyl cellulose, hydroxypropyl cellulose, diacetyl cellulose, polyvinylchloride, carboxylated polyvinyl chloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material may help improve electrode conductivity. Any suitable electrically conductive material that does not cause a chemical change may be used as the conductive material. Examples of the conductive material may include natural graphite, artificial graphite, carbon black, acetylene black, ketjen black, a carbon fiber, a metal powder or a metal fiber including copper, nickel, aluminum, silver, and so on, and a polyphenylene derivative.

The current collector may be formed from Al, but is not limited thereto.

The negative electrode 112 and positive electrode 114 may be fabricated by a method including mixing the active material, the conductive material, and the binder into an active material composition and coating the composition on the current collector. In an implementation, the solvent may include N-methylpyrrolidone but it is not limited thereto.

The electrolyte is the electrolyte according to an embodiment.

The rechargeable lithium battery may further include the separator 113 between the positive electrode 114 and negative electrode 112, as desired. The separator 113 may include any suitable material used in lithium rechargeable batteries. Non-limiting examples of suitable separator materials may include polyethylene, polypropylene, polyvinylidene fluoride, and multi-layers thereof (such as a polyethylene/polypropylene double-layered separator, a polyethylene/polypropylene/polyethylene three-layered separator, and/or a polypropylene/polyethylene/polypropylene three-layered separator).

The following Examples and Comparative Examples are provided in order to set forth particular details of one or more embodiments. However, it will be understood that the embodiments are not limited to the particular details described. Further, the Comparative Examples are set forth to highlight certain characteristics of certain embodiments, and are not to be construed as either limiting the scope of the invention as exemplified in the Examples or as necessarily being outside the scope of the invention in every respect.

### Example 1

A 1.15 M LiPF₆ solution was prepared by adding LiPF₆ to a mixed solvent prepared by mixing ethylene carbonate (EC) and ethyl propionate (EP) in a weight ratio of 2:8. Then, 0.5 wt % of lithium difluoro(oxalato)borate (LF₂OB) and 2 wt % of tris(trimethylsilyl)phosphate were added thereto, based on the total weight of the non-aqueous electrolyte, thereby preparing the non-aqueous electrolyte.

Lithium nickel cobalt manganese oxide (as a positive active material), polyvinylidene fluoride (PVDF) (as a binder), and carbon (as a conductive material) were mixed in a weight ratio of 92:4:4, and N-methyl-2-pyrrolidone was added thereto, preparing a positive slurry. The positive slurry was coated on a 20 μm-thick aluminum foil current collector, dried in a 120° C. vacuum oven, and compressed to fabricate a positive electrode.

Natural graphite (as a negative active material) and styrene-butadiene rubber (SBR) (as a binder) were mixed in a weight ratio of 92:8. N-methyl-2-pyrrolidinone was added to the mixture. The resulting mixture was dispersed, preparing negative electrode slurry. The negative electrode slurry was coated on a 15 μm-thick copper film current collector, dried in a 120° C. vacuum oven, and compressed to fabricate a negative electrode.

Then, a 25 μm-thick polyethylene porous film (as a separator) was disposed between the positive and negative electrode to fabricate an electrode assembly. The electrode assembly was spiral-wound and compressed. The resulting product was put in a cylindrical can. The non-aqueous electrolyte was added to the can. The can was sealed, fabricating a rechargeable lithium battery cell.

### Examples 2 to 6 and Comparative Examples 1 to 8

Rechargeable lithium battery cells were fabricated according to the same method as Example 1 except for using a non-aqueous electrolyte prepared by mixing components and ratios provided in the following Table 1.

TABLE 1

| | Non-aqueous solvent | | | | | Lithium salt | | | | | |
|---|---|---|---|---|---|---|---|---|---|---|---|
| | (weight ratio) | | | | | (M) | Additive (wt %) | | | | |
| | EC | EP | MP | EMC | DMC | LiPF₆ | LF₂OB | TMSP | PRS | VEC | LiBOB |
| Ex. 1 | 2 | 8 | — | — | — | 1.15 | 0.5 | 2 | — | — | — |
| Ex. 2 | 2 | 8 | — | — | — | 1.15 | 0.5 | 2 | 0.5 | | — |
| Ex. 3 | 2 | 8 | — | — | — | 1.15 | 0.5 | 2 | — | 0.5 | — |
| Ex. 4 | 2 | — | 8 | — | — | 1.15 | 0.5 | 2 | — | — | — |
| Ex. 5 | 2 | — | 8 | — | — | 1.15 | 0.5 | 2 | 0.5 | — | — |
| Ex. 6 | 2 | — | 8 | — | — | 1.15 | 0.5 | 2 | — | 0.5 | — |
| Comp. Ex. 1 | 2 | 8 | — | — | — | 1.15 | — | — | — | — | — |
| Comp. Ex. 2 | 2 | — | — | 4 | 4 | 1.15 | — | — | — | — | — |
| Comp. Ex. 3 | 2 | — | — | 4 | 4 | 1.15 | — | 2 | — | — | 0.5 |
| Comp. Ex. 4 | 2 | — | — | 4 | 4 | 1.15 | — | 2 | 0.5 | — | 0.5 |
| Comp. Ex. 5 | 2 | 8 | — | — | — | 1.15 | — | 2 | — | — | 0.5 |
| Comp. Ex. 6 | 2 | 8 | — | — | — | 1.15 | — | 2 | 0.5 | — | 0.5 |
| Comp. Ex. 7 | 2 | — | — | 4 | 4 | 1.15 | 0.5 | 2 | | — | — |
| Comp. Ex. 8 | 2 | — | — | 4 | 4 | 1.15 | 0.5 | 2 | 2 | — | — |

In Table 1, EC indicates ethylene carbonate, EP indicates ethyl propionate, MP indicates methyl propionate, EMC indicates ethylmethyl carbonate, DMC indicates dimethyl carbonate, LF₂OB indicates lithium difluoro(oxalato)borate, TMSP indicates tris(trimethylsilyl)phosphate, PRS indicates 1,3-propene sultone, VEC indicates vinylethylene carbonate, and LiBOB indicates lithium bis(oxalato)borate.

### Experimental Example

The battery cells according to the Examples and Comparative Examples were evaluated regarding battery characteristics. The results are provided in the following Table 2.

Specifically, the DC-IR at −30° C. was measured by obtaining an I-V curve after discharging the cells at 1C to 8C for 10 seconds and by predicting a DC-IR value at 2.1V from the obtained curve.

In addition, the battery capacity was measured as follows: the battery cells were allowed to stand with full-charged state (SOC100) at 60° C. for 30 days, and discharged at 0.2C at room temperature. Then, the battery cells were charged and discharged at 0.2C at room temperature and the discharge capacity was measured.

TABLE 2

| | −30° C. | | Discharge capacity after storage at |
|---|---|---|---|
| | DC-IR | | 60° C., for 30 days |
| Example 1 | 1.6 | ohm | 170 mAh |
| Example 2 | 2 | ohm | 173 mAh |
| Example 3 | 1.8 | ohm | 173 mAh |
| Example 4 | 1.4 | ohm | 170 mAh |
| Example 5 | 1.6 | ohm | 172 mAh |
| Example 6 | 1.5 | ohm | 173 mAh |
| Comparative Example 1 | 2 | ohm | 138 mAh |
| Comparative Example 2 | 2.8 | ohm | 173 mAh |
| Comparative Example 3 | 2.4 | ohm | 173 mAh |
| Comparative Example 4 | 2.8 | ohm | 175 mAh |
| Comparative Example 5 | 1.6 | ohm | 158 mAh |
| Comparative Example 6 | 2 | ohm | 163 mAh |
| Comparative Example 7 | 2.4 | ohm | 173 mAh |
| Comparative Example 8 | 2.4 | ohm | 174 mAh |

As may be seen in Table 2, the battery cells according to Examples 1 to 6 exhibited excellent low temperature characteristics and high battery capacity when allowed to stand at a high temperature, compared with those of Comparative Examples 1 to 8.

By way of summation and review, a rechargeable lithium battery may have an average discharge voltage ranging from about 3.6 to 3.7 V and a higher discharge voltage than, e.g., another alkali battery, a nickel-cadmium battery, or the like. In order to accomplish this high driving voltage, a rechargeable lithium battery may include an electrolyte solution composition that is electrochemically stable in a charge and discharge voltage region ranging from 0 to 4.2V. Accordingly, the electrolyte solution may include a mixed solvent prepared by appropriately mixing a cyclic carbonate compound (such as ethylene carbonate, propylene carbonate, and the like) and a linear carbonate compound (such as dimethyl carbonate, ethylmethyl carbonate, diethyl carbonate, and the like) and may include a lithium salt (such as LiPF₆, liBF₄, LiClO₄, and the like) as a solute. The electrolyte solution may play a role of a lithium ion source for a lithium battery.

When a lithium rechargeable battery is initially charged, lithium ions may come out from a positive active material (such as a lithium metal oxide or the like), may move toward a negative active material (such as graphite or the like), and then, may be inserted between negative active material layers.

Lithium may have strong reactivity. Thus, an electrolyte solution may react with a lithium salt on a surface of the negative active material, thereby producing a compound such as Li₂CO₃, Li₂O, LiOH, or the like. These compounds may form a SEI (Solid Electrolyte Interface) layer on the surface of the negative active material.

The SEI layer may play a role of an ion tunnel. Thus, the SEI layer may pass only lithium ions. Accordingly, the SEI layer may bring about an ion tunnel effect in which organic solvent molecules having a high molecular weight may be prevented from being inserted between negative active material layers and thereby may be prevented destroying a negative electrode when moved with lithium ions. Therefore, the SEI layer may reduce the likelihood or prevent the electrolyte solution from contacting the negative active material. Thus, the electrolyte solution may be prevented from being decomposed and resultantly, may reversibly maintain the amount of lithium ions in the electrolyte solution and, may maintain stable charge and discharge.

However, an SEI layer may not continuously protect a negative electrode and may deteriorate cycle-life and performance as a battery is repetitively charged and discharged. For example, an SEI layer for a lithium rechargeable battery may not be thermally stable. Thus, an SEI layer may be easily destroyed due to increasing electrochemical energy and thermal energy when a battery works or is allowed to stand at a high temperature. Accordingly, a propionate-based solvent may be used to improve low temperature characteristic and to prevent gas generation when a battery is allowed to stand at a high temperature. However, the propionate-based solvent may cause a side effect at a negative electrode, e.g., deteriorating capacity and power output.

The embodiments provide a non-aqueous electrolyte for a rechargeable lithium battery that may help improve battery capacity, cycle-life, and performance deterioration and prevent battery capacity deterioration and output decrease when a battery is allowed to stand at a high temperature or a room temperature as well as simultaneously heping improve battery characteristics at a low temperature.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A lithium rechargeable battery, comprising:
an electrode assembly;
a case accommodating the electrode assembly; and
an electrolyte in the case, wherein the electrolyte includes:
a lithium salt;
a non-aqueous organic solvent, the non-aqueous organic solvent including about 50 wt % or more of an ester-based solvent;
lithium difluoro(oxalato)borate; and
a first additive, the first additive including at least one selected from tris(trialkylsilyl)phosphate, tris(trialkylsilyl)phosphite, and tris(trialkylsilyl)borate.

2. The lithium rechargeable battery as claimed in claim 1, wherein the non-aqueous organic solvent includes about 50 wt % to about 90 wt % of the ester-based solvent.

3. The lithium rechargeable battery as claimed in claim 1, wherein the ester-based solvent includes at least one selected from an alkyl acetate, an alkyl propionate, and a cyclic ester.

4. The lithium rechargeable battery as claimed in claim 3, wherein the ester-based solvent includes the alkyl acetate, the alkyl acetate including at least one selected from methyl acetate, ethyl acetate, n-propyl acetate, and isopropyl acetate.

5. The lithium rechargeable battery as claimed in claim 3, wherein the ester-based solvent includes the alkyl propionate, the alkyl propionate including at least one selected from methyl propionate, ethyl propionate, n-propyl propionate, and isopropyl propionate.

6. The lithium rechargeable battery as claimed in claim 3, wherein the ester-based solvent includes the cyclic ester, the cyclic ester including at least one selected from γ-butyrolactone, decanolide, valerolactone, mevalonolactone, and caprolactone.

7. The lithium rechargeable battery as claimed in claim 1, wherein the non-aqueous organic solvent further includes at least one selected from a carbonate-based solvent, an ether-based solvent, a ketone-based solvent, an alcohol-based solvent, and an aprotic solvent.

8. The lithium rechargeable battery as claimed in claim 7, wherein:
the non-aqueous organic solvent includes the carbonate-based solvent, the carbonate-based solvent being a cyclic carbonate, and
the ester-based solvent and the cyclic carbonate are included in a weight ratio of about 4:1 to about 1:1.

9. The lithium rechargeable battery as claimed in claim 1, wherein the lithium difluoro(oxalato)borate is included in the electrolyte in an amount of about 0.1 wt % to about 5 wt %, based on a total weight of the electrolyte.

10. The lithium rechargeable battery as claimed in claim 9, wherein the lithium difluoro(oxalato)borate is included in the electrolyte in an amount of about 0.5 wt % to about 5 wt %, based on a total weight of the electrolyte.

11. The lithium rechargeable battery as claimed in claim 1, wherein the first additive includes the tris(trialkylsilyl)phosphate, the tris(trialkylsilyl)phosphate including at least one selected from tris(trimethylsilyl)phosphate, tris(triethylsilyl)phosphate, and tris(tripropylsilyl)phosphate.

12. The lithium rechargeable battery as claimed in claim 1, wherein the first additive includes the tris(trialkylsilyl)phosphite, the tris(trialkylsilyl)phosphite including at least one selected from tris(trimethylsilyl)phosphite, tris(triethylsilyl)phosphite, and tris(tripropylsilyl)phosphite.

13. The lithium rechargeable battery as claimed in claim 1, wherein the first additive includes the tris(trialkylsilyl)borate, the tris(trialkylsilyl)borate including at least one selected from tris(trimethylsilyl)borate, tris(triethylsilyl)borate, and tris(tripropylsilyl)borate.

14. The lithium rechargeable battery as claimed in claim 1, wherein the first additive is included in the electrolyte in an amount of about 0.1 wt % to about 5 wt %, based on a total weight of the electrolyte.

15. The lithium rechargeable battery as claimed in claim 1, wherein the electrolyte includes the lithium difluoro(oxalato)borate and the first additive in a weight ratio of about 1:0.5 to about 1:4.

16. The lithium rechargeable battery as claimed in claim 1, wherein the electrolyte further includes a second additive, the second additive including at least one selected from 1,3-propene sultone and vinylethylene carbonate.

17. The lithium rechargeable battery as claimed in claim 16, wherein the second additive is included in the electrolyte in an amount of about 0.1 wt % to about 5 wt %, based on a total weight of the electrolyte.

18. The lithium rechargeable battery as claimed in claim 1, wherein:
the electrode assembly includes a positive electrode plate and a negative electrode plate, the positive electrode plate including a positive active material and the negative electrode plate including a negative active material,
the positive active material includes a compound that reversibly intercalates and deintercalates lithium, and
the negative active material includes a material that reversibly intercalates/deintercalates lithium ions, lithium metal, an alloy of lithium metal, a material that dopes and dedopes lithium, or a transition metal oxide.

19. An electrolyte for a lithium rechargeable battery, the electrolyte comprising:
a lithium salt;
a non-aqueous organic solvent, the non-aqueous organic solvent including about 50 wt % or more of an ester-based solvent;
lithium difluoro(oxalato)borate; and
a first additive, the first additive including at least one selected from tris(trialkylsilyl)phosphate, tris(trialkylsilyl)phosphite, and tris(trialkylsilyl)borate.

20. A method of manufacturing a lithium rechargeable battery, the method comprising:
preparing an electrode assembly;
accommodating the electrode assembly in a case;
adding an electrolyte to the case; and
sealing the case,
wherein the electrolyte includes:
a lithium salt;
a non-aqueous organic solvent, the non-aqueous organic solvent including about 50 wt % or more of an ester-based solvent;
lithium difluoro(oxalato)borate; and
a first additive, the first additive including at least one selected from tris(trialkylsilyl)phosphate, tris(trialkylsilyl)phosphite, and tris(trialkylsilyl)borate.
